(19) United States
(12) Patent Application Publication
(10) Pub. No.: US 2010/0033781 A1
(43) Pub. Date: Feb. 11, 2010

(54) Method and Apparatus for Encoding Computer-Generated Holograms in Pixelated Light Modulators

(75) Inventor: Norbert Leister, Dresden (DE)

Correspondence Address: Saul Ewing LLP (Philadelphia), Attn: Patent Docket Clerk, 2 North Second St., Harrisburg, PA, 17101, US

(73) Assignee: SeeReal Technologies S.A., Munsbach (LU)

(21) Appl. No.: 12/440,478

(22) PCT Filed: Aug. 27, 2007
(86) PCT No.: PCT/EP07/58883

§ 371 Date: Sep. 30, 2009

(30) Foreign Application Priority Data
Sep. 9, 2006 (DE) 102006042467.0

(51) Int. Cl. G03H 1/08

(52) U.S. Cl. 359/9

(57) ABSTRACT

The object is to largely eliminate the errors which arise in the reconstruction of a hologram, calculated point by point, as a result of the encoding of said hologram into pixels of finite extent. The invention achieves the object by means of a method in which the common wavefront calculated from the object sectional planes is multiplied by the inverse transform of the pixel shape and pixel transparency in the viewer's window before the wavefront modified by the multiplication is transformed to the hologram plane and encoded as an amplitude and/or phase distribution of the hologram in the pixels of the light modulator. This method is implemented in a corresponding apparatus which contains an additional memory unit for providing a Fourier transform or its inverse Fourier transform and also a multiplication unit.

The present invention relates to a method and device for encoding computer-generated holograms in pixelated light modulators in consideration of the defect which is caused by the pixel shape and pixel transparency during reconstruction.

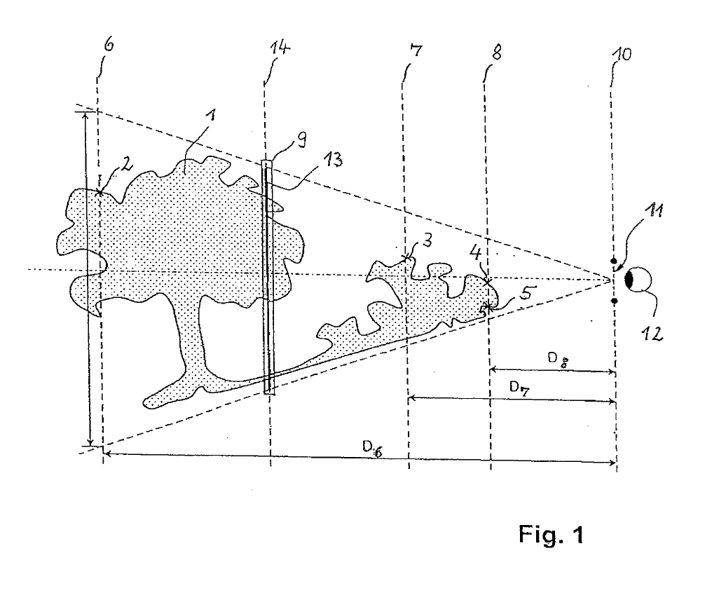

A method for calculating computer-generated video holograms and a corresponding device are known from document DE 10 2004 063 838 A1, where, as shown in FIG. 1, object points with complex amplitude values of a three-dimensional original object 1 are assigned to matrix dots 2, 3, 4, 5 of parallel virtual object section planes 6, 7, 8, in order to define for each object section plane 6, 7, 8 a separate object data set with discrete amplitude values in matrix dots of a given matrix, and to calculate from the object data sets a holographic code for the pixel matrix of a light modulator 9.

A diffraction image in the form of a separate two-dimensional distribution of wave fields is calculated from each object data set of each object section plane 6, 7, 8 for a reference plane 10, which is situated at a finite distance D₆, D₇, D₈ and parallel to the object section planes 6, 7, 8, where the wave fields of all object section planes are calculated for at least one aggregated virtual observer window 11, which is situated in the reference plane 10 near the observer eyes 12, where the area of said observer window 11 is reduced compared with the hologram 13.

The calculated distributions for the wave fields of all object section planes 6, 7, 8 are added in a reference data set in order to define an aggregated wave field for the virtual observer window 11. For generating a hologram data set for the common computer-generated hologram 13 of the object 1, the reference data set is transformed into a hologram plane 14, which is situated at a finite distance and parallel to the reference plane 10 that coincides locally with the pixel matrix of the light modulator 9.

The amplitude and phase values of the hologram, which are to be realised in the individual pixels, are also calculated dot by dot for the hologram plane 14.

Typically, two-dimensional light modulators with an encoding surface of m pixel rows at n pixels each are used for recording computer-generated holograms, where the pixels are not dots, but have a finite extent and a given shape and a certain amplitude transparency and phase transparency.

Further, it is common practice when describing optical paths to use an xyz coordinate system related to the encoding surface of the light modulator, where x usually denotes the horizontal direction, y the vertical direction and z the normal direction to the encoding surface, and where in the encoding surface n pixels are arranged in a pixel row in the x direction and m pixel rows are arranged in the y direction.

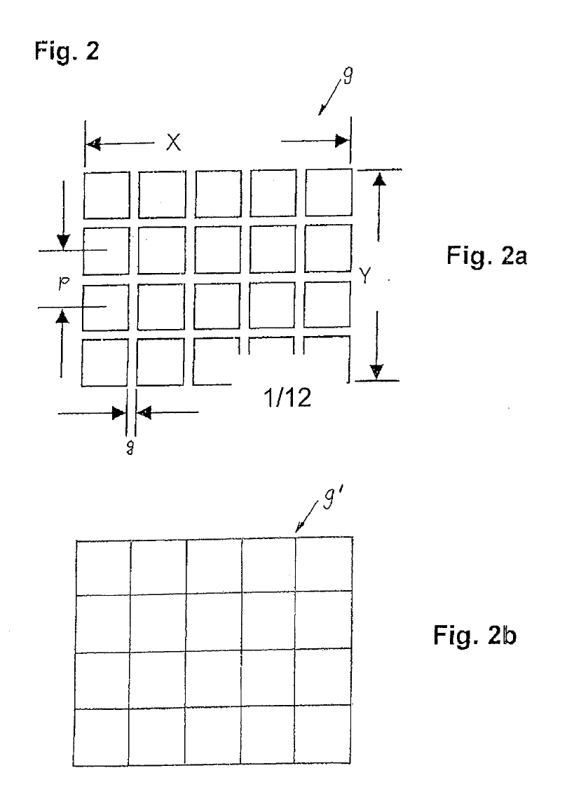

Light modulators with the encoding surfaces shown in FIG. 2 are either of a transmissive or of a reflective type and consist of a matrix of pixels with finite extent, which are separated by more or less wide gaps, owing to the manufacturing process. In the case of a liquid crystal modulator, the encoding surface is e.g. crossed by a grid of thin electrodes, where the grid represents a matrix of electrodes which intersect at right angles, thus defining rectangular regions between the electrodes, the so-called pixels, which are disposed at a certain distance to each other, the so-called pixel pitch p. The matrix of electrodes is also known as the inter-pixel matrix or gap grid, because it exhibits gaps g between the pixels. It can be switched with the help of an electronic controller, in particular with the help of a computer with technical programming means, in order to encode the pixels as regards their amplitude and/or phase such that they exhibit a certain transparency or reflection. Pixels which are encoded as transmissive pixels let the incident waves pass, while the pixels which are encoded as reflective pixels reflect the incident waves.

The difference between the usual types of encoding surfaces is shown in FIG. 2, where FIG. 2a is a detail of the encoding surface of a transmissive light modulator 9 and FIG. 2b is a detail of the encoding surface of a reflective light modulator 9′. The transmissive light modulator 9 has a fill factor which is noticeably lower than 100%, while the reflective light modulator 9′ has a fill factor of almost 100%, i.e. the pixels are almost seamlessly adjoined. However, reflective light modulators in practice usually also have fill factors which are lower than 100%.

One problem of the prior art is that the dot-by-dot calculation of the hologram and its representation in pixels with finite extent on the light modulators 9, 9′ cause an adulteration, and the reconstruction of the original object 1, which is watched by the observer, shows instances of imprecision.

The occurring defects are caused by the real extent of the pixels, which are based on a conflict between the dot-by-dot calculation of the hologram and the real extent of the pixels, which remains unconsidered.

It is also known that the rectangular pixels of the light modulator, given a uniform transparency or reflectance, exhibit an amplitude distribution in the form of a sinc function of

$$sin c ( x ) = \frac{sin ( π x )}{π x}$$

in a Fourier plane, if they are illuminated with coherent light.

The calculation of the complex light distributions in the plane of the observer window 11 and in the hologram plane 14 is only valid for dots which are intersecting points of a given virtual grid. If the complex distributions are represented on a light modulator 9, 9′, there are pixels which are for example of rectangular shape and which exhibit constant amplitude transparency and/or phase transparency. The representation of the complex hologram values in the pixels of a real light modulator is mathematically a convolution of the calculated hologram with a rectangular function that represents the pixel extent in the x and y directions, as shown in FIG. 2a. This process, known mathematically as convolution, causes during the reconstruction of the hologram 13 in the plane of the observer window 11 the Fourier transform of the ideal hologram, which is encoded dot by dot, to be multiplied with a sinc function which is the Fourier transform of the pixel function, which is, as shown in FIG. 2, a rectangle. The reconstruction of the object 1 is thus perceived by the observer with this defect.

The size of an observer window is given as the visibility region for an observer in the reference plane 10, it may for example have the size of an eye pupil.

One problem is that the complex wave front in the given observer window 11 and thus also the reconstruction of the three-dimensional object 1 within the volume between the observer window 11 and the hologram 13 are adulterated by the effects of the finite pixel extent in the light modulator 9, 9′. For example, with a reconstruction in the 0th diffraction order, the amplitude distribution of the wave front in the observer window 11 is smaller towards the edges than it would be in the case with ideal dot pixels, due to the multiplicative superimposition of the sinc function.

Complex numbers can usually not be written directly into light modulators, but for example only amplitude values or only phase values. With the help of a suitable encoding method, a complex number is represented by multiple amplitude or phase values, which are written into adjacent pixels of the light modulator.

In the case of Burckhardt encoding, for example, a complex number is represented by three amplitude values. More generally, N*M complex numbers are represented by 3N*M amplitude values.

If one complex value is written into k pixels of a light modulator, only the 1/k^{th} portion of the Fourier transform of the written values corresponds with the Fourier transform of the complex value.

Given an array of 3N*M Burckhardt components, there will be 3N*M complex values after the Fourier transformation, of which only ⅓, i.e. M*N, complex values correspond with the Fourier transform of the 3N*M complex hologram values.

Because of the scanning in the hologram plane, there will be a periodic continuation of the Fourier transform in the observer plane. A portion 1/k of this repeating region can be used as a virtual observer window.

In the case of a phase encoding with k phase values, e.g. in the context of an iterative optimisation, a region 1/k in the Fourier plane can for example be chosen in which the virtual observer window lies.

In the case of this encoding method, the representation of the hologram values in the pixels of a real light modulator again corresponds to a convolution of the encoded hologram with a function that represents the size and transparency of a single pixel of the light modulator, even if a complex number is represented by multiple pixels.

In the reconstruction of the hologram, in the plane of the observer window, the Fourier transform of the ideal hologram, which is encoded object point by object point, is multiplied with the Fourier transform of the pixel shape and transparency, e.g. with a sinc function.

The reconstruction of the object is thus perceived with a defect again.

It is therefore an object of the present invention to provide a method and device for encoding computer-generated holograms on pixelated light modulators, said method and device being designed such that the adulteration of the reconstruction of the hologram which is caused by the real pixel extent of the light modulator is widely eliminated.

The object of the invention is solved by the features of claims 1 and 2. According to the method for encoding computer-generated holograms in pixelated light modulators, object points with complex amplitude values of a three-dimensional original object are assigned to matrix dots of parallel virtual object section planes, so that for each object section plane individual object data sets are defined with discrete amplitude values for the matrix dots, and a holographic encoding for the pixel matrix of a light modulator is calculated from the object data sets,

where from each object data set of each object section plane a diffraction pattern is calculated in the form of a separate two-dimensional distribution of wave fields for a reference plane, which is disposed at a finite distance and parallel to the object section planes, where the wave fields of all object section planes are calculated for at least one aggregated virtual observer window, which lies in the reference plane near the eyes of an observer and whose window area is reduced compared with the hologram, and where the calculated complex wave fields of all object section planes for describing an aggregated wave field for the window are added in a reference data set, which is transformed into a hologram plane, which is disposed at a finite distance and parallel to the reference plane, and which coincides locally with the pixel matrix of the light modulator, for the generation of a hologram data set for the common computer-generated hologram of the object,
where according to the characterising clause of claim 1
the wave front in the observer window, which is calculated from the object section planes, is multiplied with the inverse transform of the pixel shape and pixel transparency, before the wave front modified by the multiplication is transformed into the hologram plane and encoded in the pixels of the light modulator in the form of an amplitude distribution and phase distribution of the hologram. The inverse transform is understood in this document to be the reciprocal of the transform.

Thereby the transforming relation between the reference plane and the hologram plane can be a Fourier transformation.

In this case, the sinc function is used as the Fourier transform for the multiplication for pixels with rectangular shape and uniform amplitude transparency and phase transparency.

In case of other pixel structures or pixel shapes other than the rectangular shape or other transparency gradients in the respective encoding surface of the light modulators, transformations other than the sinc function can be used for the multiplication.

The method is realised in the device for encoding computer-generated holograms in pixelated light modulators, comprising a computer with a processing unit with at least one memory unit for storing the wave front in the observer window, which is calculated from the object section planes, and a manager, and with an output unit, which is connected with the light modulator and which writes the calculated amplitude and phase distribution of the hologram pixel by pixel to the encoding surface of the light modulator,

where according to the characterising clause of claim 5
the processing unit
comprises a second memory unit for storing the transforms of the pixels contained in the encoding surface and
comprises a multiplication unit comprising multiplication means which combine the values which are read out of the two memory units and assigned accordingly such that the aggregated wave front calculated for the observer window is multiplied with the inverse transform of the pixels of the encoding surface.

The second memory unit may also be provided for immediate storage of the inverse transforms of the pixels contained in the encoding surface such that means for the formation of the inverse transformation can be omitted in the multiplication unit. However, means for the formation of the inverse transforms, before they are written into the second memory unit, are provided in the processing unit.

The present invention is described in more detail with the help of an embodiment and a number of drawings, wherein

FIG. 1 is a schematic diagram which illustrates a method for the reconstruction of a three-dimensional object with a computer-generated hologram,

FIG. 2 is a schematic view of details of encoding surfaces in light modulators, whereby

FIG. 2a shows a transmissive light modulator with a fill factor which is lower than 100%, and

FIG. 2b shows a reflective light modulator with a fill factor of about 100%,

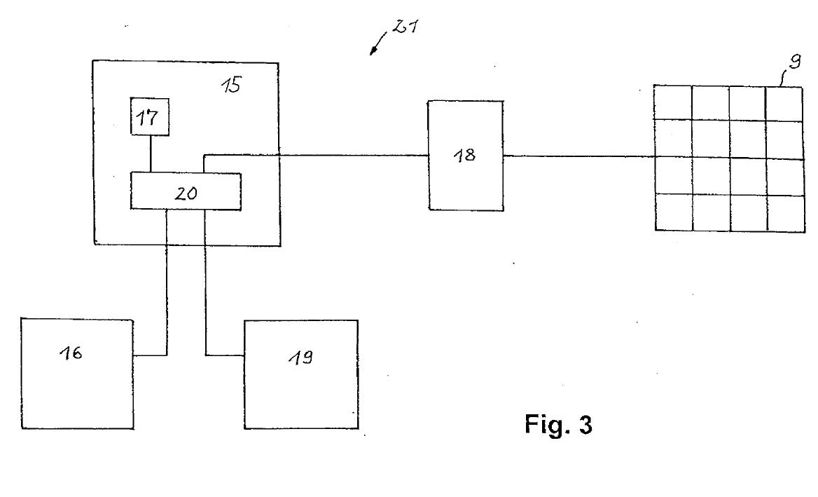

FIG. 3 is a block diagram which illustrates a device for the generation, i.e. calculation and encoding, of a modified computer-generated hologram,

FIG. 4 shows as a sample application the amplitude of an object function with arbitrary phase, where the coordinates are given in arbitrary units,

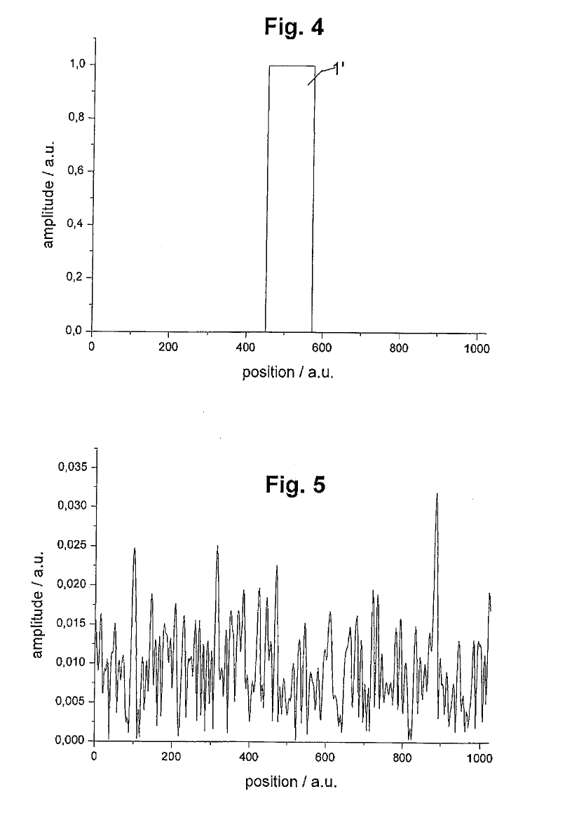

FIG. 5 shows the ideal amplitude distribution of the wave front in the given observer window, said distribution being calculated on the basis of an object function with the amplitude shown in FIG. 4 and an arbitrary phase by way of a Fresnel transformation (FrT),

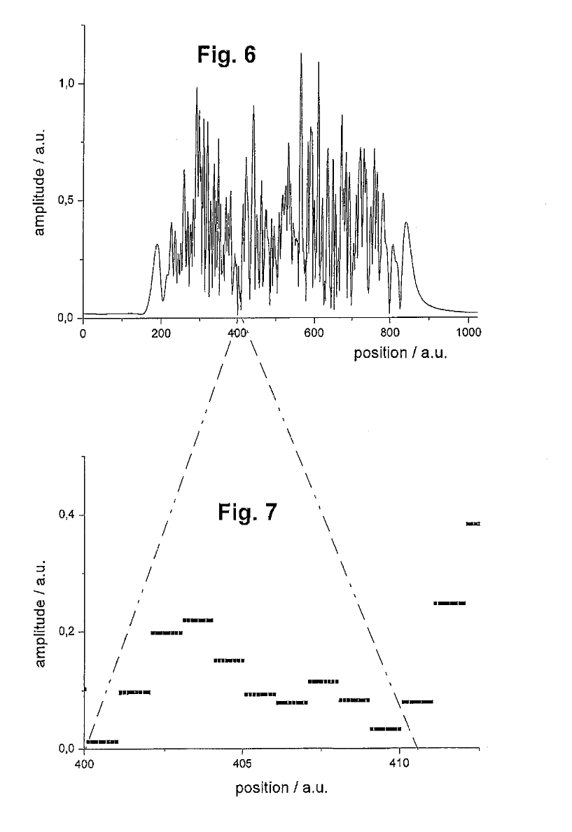

FIG. 6 shows the amplitude distribution which is calculated dot by dot in the hologram for encoding in the light modulator based on the wave front shown in FIG. 5 by way of a Fourier transformation (FT),

FIG. 7 is a magnified view of the region between 400 and 410 in FIG. 6, where the individual amplitude values cannot be represented by points due to the pixel shape, but which are distributed across the pixel extent, given a fill factor of 100%,

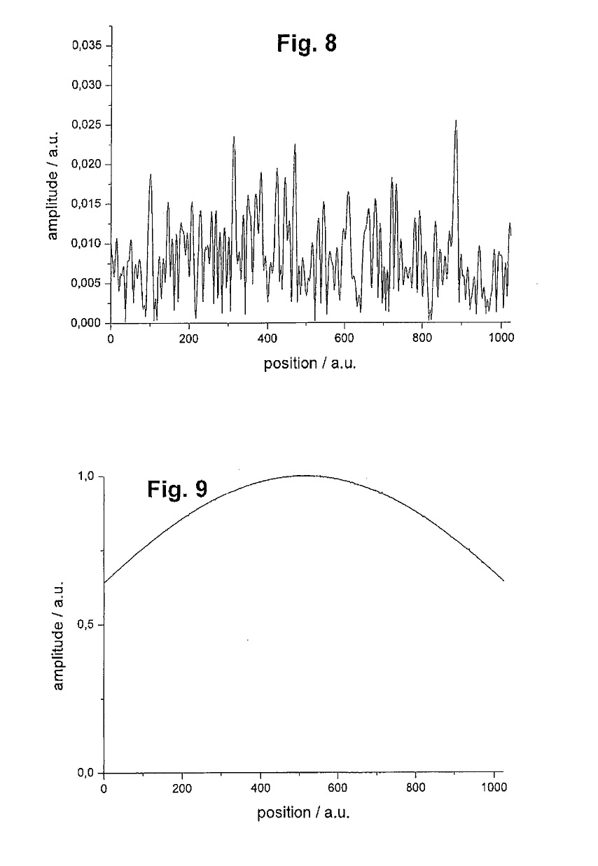

FIG. 8 shows an actual amplitude distribution of the wave front reconstructed from the hologram as shown in FIG. 7 in the visibility region, where the amplitude distribution is calculated by way of a Fourier backtransformation, which is identical to the reconstruction of the real hologram,

FIG. 9 is a diagram with the quotient of the values of the distribution shown in FIG. 8 and the corresponding values of the distribution shown in FIG. 5, where the curve corresponds with the central section of a sinc function (sin x/x).

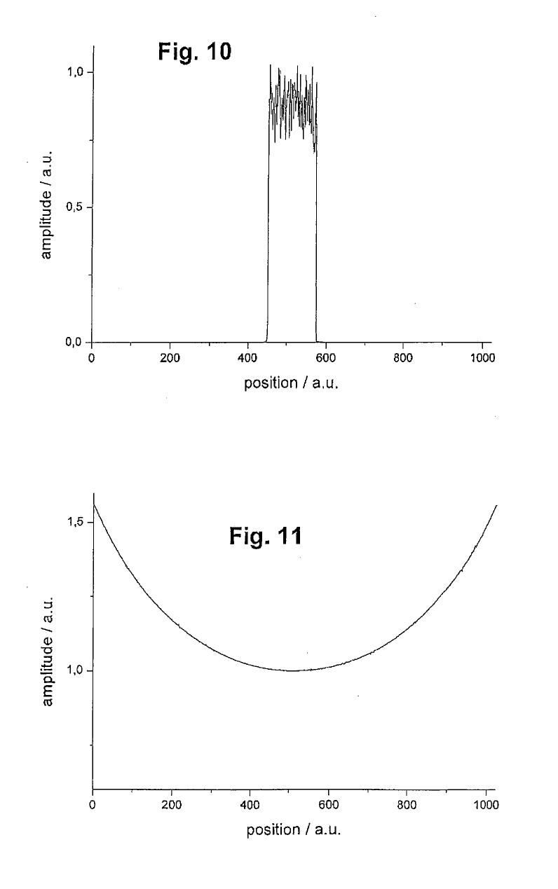

FIG. 10 shows the reconstructed object on the basis of the real wave front in the observer window according to FIG. 8, as it is observable by an observer,

FIG. 11 shows the inverse sinc function according to FIG. 9, with which the ideal amplitude distribution is multiplied in the observer window according to FIG. 5 before it is transformed into the hologram plane,

FIG. 12 shows the result of the multiplication of the amplitude distribution from FIG. 5 with the inverse Fourier transform of the pixels (1/sinc function) according to FIG. 11,

FIG. 13 shows the amplitude distribution of the modified hologram, which represents the result of the Fourier transformation of the modified wave front according to FIG. 12 into the hologram plane,

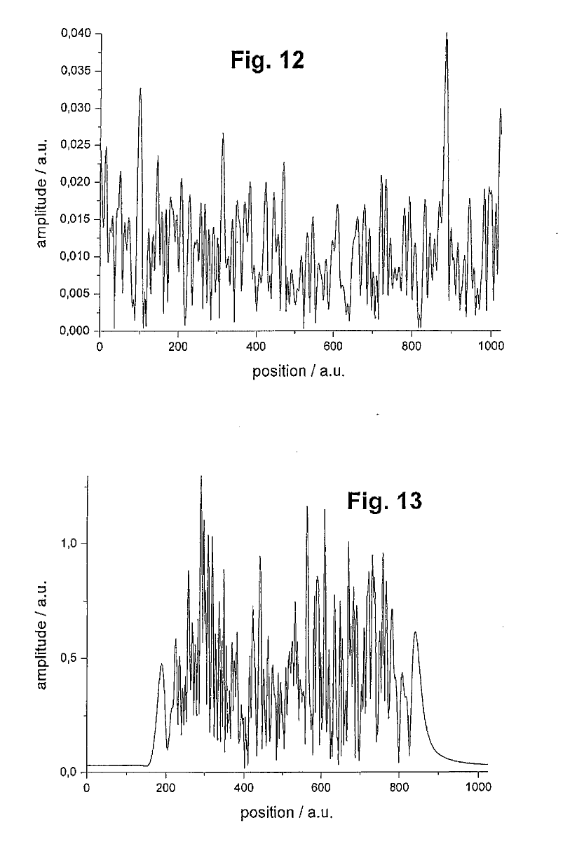

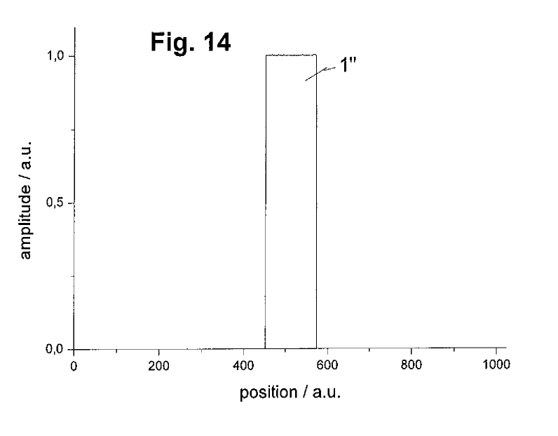

FIG. 14 shows a view of the reconstruction of the modified hologram, which corresponds with the original object and which is observable by an observer in the observer window,

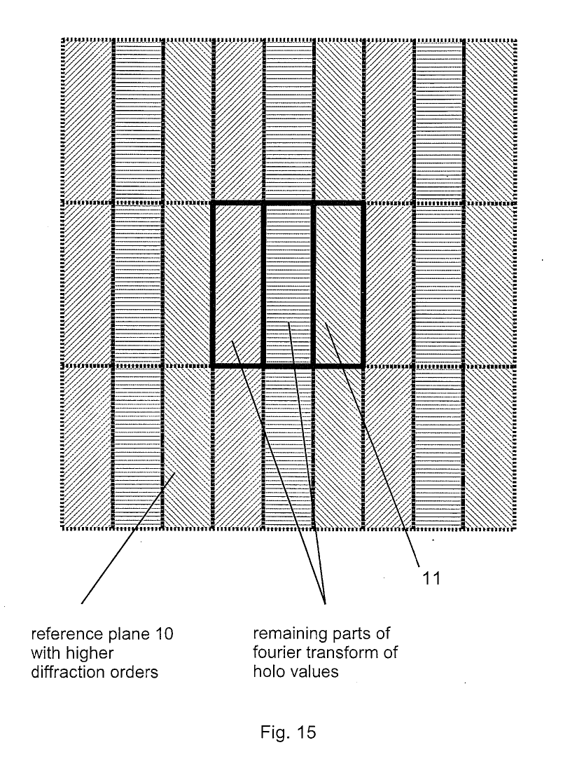

FIG. 15 shows a depiction of the transforms of the hologram values written to the light modulator and their periodic continuation in a virtual observer plane when using the Burckhardt encoding method,

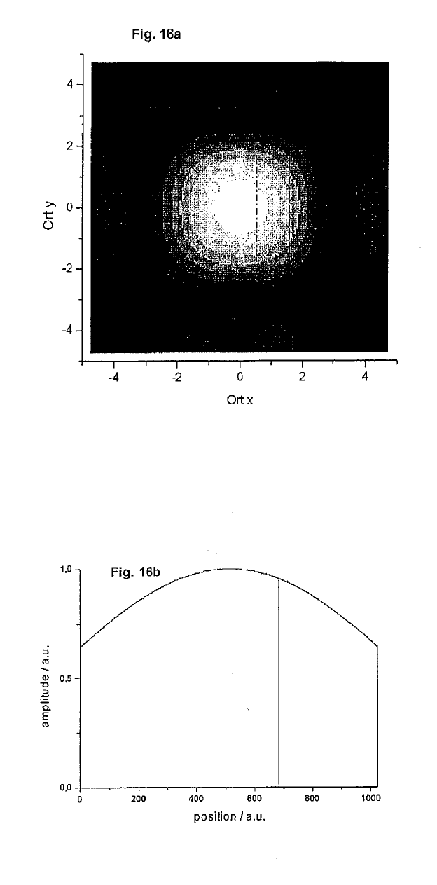

FIG. 16a shows schematically a top view of a horizontal cross-section of the Fourier transform of a pixel with square amplitude transparency as a greyscale representation with a highlighted observer window,

FIG. 16b shows a horizontal cross-section of the Fourier transform of a pixel with rectangular amplitude transparency as a detail of a sinc function, where the observer window is indicated for the Burckhardt encoding method, and

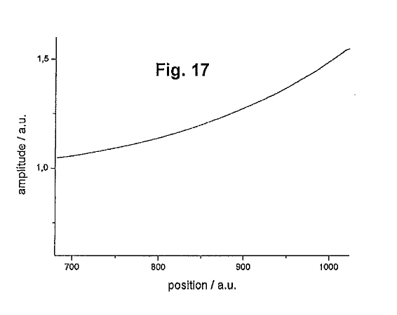

FIG. 17 shows the plot of the respective corrective function for the Burckhardt encoding as an inverse function of the right-hand side third of the function shown in FIG. 16b.

According to the method for encoding computer-generated holograms in pixelated light modulators, object points with complex amplitude values of a three-dimensional original object 1 are assigned to matrix dots 2, 3, 4, 5 of parallel virtual object section planes 6, 7, 8, as shown in FIG. 1, so that for each object section plane 6, 7, 8 individual object data sets are defined with discrete amplitude values for the matrix dots, and a holographic code for the pixel matrix of a light modulator 9 is calculated from the object data sets,

where a diffraction pattern from each object data set of each object section plane 6, 7, 8 is calculated in the form of a separate two-dimensional distribution of wave fields for a reference plane 10, which is disposed at a finite distance and parallel to the object section planes 6, 7, 8, whereby the wave fields of all object section planes are calculated for at least one aggregated observer window 11, which lies in the reference plane 10 near the eyes 12 of an observer and whose window area is reduced compared with the hologram 13, and whereby the calculated distributions of the wave fields of all object section planes 6, 7, 8 for the description of an aggregated wave field for the observer window 11 are added in a reference data set, where the reference data set is transformed into a hologram plane 14, which is disposed at a finite distance and parallel to the reference plane 10, and which coincides locally with the pixel matrix of the light modulator 9, for the generation of a hologram data set for the common computer-generated hologram 13 of the object 1.

According to the invention, the wave front in the observer window 11, which is calculated from the object section planes 6, 7, 8, is multiplied with the inverse transform of the pixel shape and pixel transparency before the wave front modified by the multiplication is transformed into the hologram plane 14 and encoded in the pixels of the light modulator 9 in the form of an amplitude distribution and/or phase distribution of the hologram 13.

The correction can be specified for a light modulator 9 which has pixels of rectangular shape and a uniform amplitude and phase transparency. The inverse transform is then an inverse sinc function. However, it can also be provided for light modulators which have other pixel shapes and pixel transparency values. The corresponding inverse transform of the actual pixel shape and transparency must be used in that case.

Consequently, there may be transforming relations between the reference plane 10 and the hologram plane 14 other than the Fourier transformation mentioned above.

The device 21 for encoding computer-generated holograms in a pixelated light modulator 9, which is illustrated in the form of a block diagram in FIG. 3, comprises a computer with a processing unit 15 with at least one memory unit 16 for storing the wave front in the observer window 11, which is calculated from the object section planes 6, 7, 8, and a manager 17, and with an output unit 18, which is connected with the light modulator 9, and which writes the calculated amplitude and phase distribution of the hologram pixel by pixel into the encoding surface of the light modulator 9, whereby the processing unit 15
comprises a second memory unit 19 for storing the Fourier transforms of the pixels contained in the encoding surface and
comprises a multiplication unit 20 comprising multiplication means, not shown, which combine the values which are read out of the two memory units 16, 19 and assigned accordingly by the manager 17 such that the wave front calculated for the observer window 11 is multiplied with the inverse Fourier transform of the pixels of the encoding surface.

The second memory unit 19 may also be provided for immediate storage of the inverse Fourier transforms of the pixels contained in the encoding surface such that means for the formation of the inverse Fourier transforms can be omitted in the multiplication unit 20. However, means for the formation of the inverse Fourier transforms, not shown, before they are written into the second memory unit 19, can be provided in the processing unit 15.

The method according to this invention is simulated with the example of an encoding with one pixel per complex value by way of calculation in one dimension, where FIGS. 4 to 13 show the following:

FIG. 4 shows the curve of a one-dimensional object function 1′ with constant amplitude and an arbitrary phase. The coordinates are labelled with arbitrary units.

FIG. 5 shows the ideal amplitude distribution of the wave field in the given observer window 11, which is calculated by way of a Fresnel transformation (FrT) based on said one-dimensional object function 1′.

FIG. 6 shows the amplitude distribution in the hologram in the plane of the light modulator, said distribution being calculated based on the wave front shown in FIG. 5 by way of a Fourier transformation (FT).

FIG. 7 is a magnified detail of FIG. 6 which shows that after encoding the hologram on the light modulator the individual amplitude values are not points, due to the pixel shape, but are distributed across a finite pixel extent. The diagram shows the real encoding, assuming a fill factor of 100%.

FIG. 8 shows the actual amplitude distribution of the wave front in the observer window 11, which results from the inverse Fourier transformation of the encoded hologram shown in FIG. 7. This represents the reconstruction of the real hologram, which was calculated and encoded according to prior art solutions, but which has not yet been corrected as regards the pixel shape.

FIG. 9 is a diagram with the quotient of the values of the distribution of the wave fields shown in FIG. 8 and the corresponding values of the distribution shown in FIG. 5. There is no visible difference between these two distributions at first glance. The result is, however, that the quotient is a section of the 0-th diffraction order of a rectangular function which corresponds with a sinc function. If a higher diffraction order is used instead of the 0-th diffraction order for reconstruction, the method can be applied as well. In that case, however, it is not the central section of the sinc function or of its inverse function that shall be used for correction, but a section that lies more outward.

FIG. 10 shows the reconstructed object based on the real wave front in the observer window 11 as shown in FIG. 8, said wave front being attenuated at its margins compared with the ideal wave front, where the reconstructed object represents the adulteration that is caused by that effect and that effect is to be eliminated with the help of the inventive method.

FIG. 11 shows the central section of the inverse sinc function, with which the amplitude distribution of the ideal wave field in the observer window 11 is multiplied, before it is transformed into the hologram, in order to eliminate the error caused by the pixel extent according to FIG. 2a and FIG. 2b.

FIG. 12 shows the result of the inventive multiplication of the amplitude distribution of the ideal wave field shown in FIG. 5 with the selected section of the inverse sinc function (1/sinc) according to FIG. 11.

FIG. 13 shows the Fourier transform of FIG. 12, i.e. the amplitude distribution of the modified hologram.

FIG. 14 shows a reconstruction 1″, which is observable by an observer and corrected as regards pixel shape and pixel transparency, said reconstruction 1″ corresponding with the original object 1′.

Encoding the hologram modified according to the invention on the light modulator 9, 9′, there will result the values shown in FIG. 5, i.e. the ideal wave front, during the reconstruction in the observer window 11, despite the finite extent of the pixels. Thereby also the ideal reconstructed object 1″ shown in FIG. 14 and not the adulterated reconstructed object shown in FIG. 10 will be observed if the observer eyes are situated in the given observer window 11.

In the case of other pixel structures and other pixel shapes or other transparency gradients in the encoding surface of the light modulators, e.g. if the pixels deviate from an ideal rectangular shape or if they are arranged irregularly, their Fourier transforms differ from the sinc function. The transforms or their inverse functions which differ from the sinc function are then used for the inventive correction of the holograms.

The method can also be employed if the complex hologram values in the light modulator are not encoded in one pixel, but phase and amplitude are encoded in multiple pixels for each complex value.

FIGS. 15 to 17 show schematically examples for a Burckhardt encoding, where a complex value is represented by the amplitude transparency of three adjacent pixels. The sections are only shown one-dimensionally, in order to keep things simple.

FIG. 15 shows in the centre of the reference plane 10, a virtual observer plane, the transform of the Burckhardt components written into the light modulator 9 or 9′ and, towards the margins, their periodic continuation. Therein, ⅓ of the transform serves as the virtual observer window 11. This third is horizontally out of centre.

In order to correct the defect, it must be multiplied with that section of the inverse transform of the pixel shape and transparency that lies within the virtual observer window 11.

FIG. 16a shows schematically in a top view the Fourier transform of a square pixel with constant transparency as a greyscale representation. The Fourier transform here is the product of the two functions sinc(a·x) and sinc(a·y) with a fixed factor a.

A rectangular box indicates the position of the virtual observer window 11 in the Fourier plane in the case of a Burckhardt encoding, as shown in FIG. 15.

FIG. 16b shows the plot in a one-dimensional horizontal cross-section in the Fourier plane at the position y=0, similar to the drawing in FIG. 9. In this Figure, the virtual observer window 11 is again indicated by a box.

FIG. 17 shows the inverse function for this cross-section from FIG. 16b to be used for correction. Only that section of the function that lies within the virtual observer window 11 is used for correction.

The correction illustrated in FIGS. 16b and 17 with the help of cross-sectional views must be applied to the entire area of the virtual observer window 11.

Even if an amplitude or phase encoding method is used, a correction of the complex values can preferably already take place in the virtual observer window 11, before a division into amplitude and phase values is effected in the hologram.

The procedure illustrated using the example of the Burckhardt encoding method here can also be applied to other encoding methods, such as the phase encoding method. The correction of the reconstruction described can also be combined with the iterative optimisation of the phase encoding method disclosed by the applicant in document DE 10 2006 003 741 A1. It will then for example only be necessary for the correction to be performed once, prior to the iteration. This means that only modified set-point values will be generated for the iteration; the iteration process itself will remain unchanged.

As shown in the example described above, in addition to the pixel shape and transparency, the number and arrangement of the pixels which represent one complex value, i.e. the encoding method, must be known for determining the corrective function.

Likewise, the method described above can also be applied in the case of being a transforming relation other than the Fourier transformation between the reference plane and the hologram plane.

### LIST OF REFERENCE NUMERALS

1 First object
1′ Second object
1″ Reconstruction
2 First matrix dot
3 Second matrix dot
4 Third matrix dot
5 Fourth matrix dot
6 First section plane
7 Second section plane
8 Third section plane
9 Transmissive light modulator
9′ Reflective light modulator
10 Reference plane
11 Observer window
12 Eyes
13 Hologram
14 Hologram plane
15 Processing unit
16 First memory unit
17 Manager
18 Output unit
19 Second memory unit
20 Multiplication unit
21 Device

1. Method for encoding computer-generated holograms in pixelated light modulators
where object points with complex amplitude values of a three-dimensional original object are assigned to matrix dots of parallel virtual object section planes, so that for each object section plane individual object data sets are defined with discrete amplitude values for the matrix dots, and a holographic code for the pixel matrix of a light modulator is calculated from the object data sets,
where a diffraction image in the form of a separate two-dimensional distribution of wave fields is calculated from each object data set of each object section plane for a reference plane, which is situated at a finite distance and parallel to the object section planes,
where the wave fields of all object section planes are calculated for at least one joint observer window, which is situated in the reference plane near the observer eyes and whose area is reduced compared with the hologram, and
where the calculated complex wave fields of all object section planes for the description of an aggregated wave field for the joint observer window are added in a reference data set, which is transformed into a hologram plane, which is disposed at a finite distance and parallel to the reference plane, and which coincides locally with the pixel matrix of the light modulator, for generating a hologram data set for the common computer-generated hologram of the object, wherein the wave front in the observer window, which is calculated from the object section planes is multiplied with the inverse transform of the pixel shape and pixel transparency before the wave front that is modified by the multiplication is transformed into the hologram plane and is encoded in the pixels of the light modulator in the form of an amplitude—and/or phase distribution of the hologram.

2. Method according to claim 1, wherein the transforming relation between the reference plane and the hologram plane is a Fourier transformation.

3. Method according to claim 2, wherein for pixels with rectangular shape and uniform transparency the sinc function is used as the Fourier transform.

4. Method according to claim 2, wherein in case of other than rectangular pixel shapes, with more complex pixel structures or shapes in the respective encoding surface of the light modulators, transformations other than the sinc function can be used for the multiplication.

5. Device for encoding computer-generated holograms in pixelated light modulators, comprising a computer with a processing unit with at least one memory unit for storing the wave front in the observer window, said wave front is calculated from the object section planes, and comprising a manager and an output unit, which is connected with the light modulator and which writes the calculated amplitude—and/or phase distribution of the hologram pixel by pixel to the encoding surface of the light modulator, according to the method claimed in claim 1, wherein the processing unit
comprises a second memory unit for storing the transforms of the pixels contained in the encoding surface and
comprises a multiplication unit comprising multiplication means which combine the values which are read out of the two memory units and assigned accordingly by the manager such that the wave front calculated for the observer window is multiplied with the inverse transform of the pixels of the encoding surface.

6. Device according to claim 5, wherein the second memory unit for immediate storage of the inverse transforms of the pixels contained in the encoding surface.

7. Device according to claim 5, wherein means are provided for the generation of the inverse transforms before they are written into the second memory unit in the processing unit.

8. Device according to claim 5, wherein the Fourier transform or the inverse Fourier transform of the pixels contained in the encoding surface is stored in the second memory unit.

9. Device according to claim 6, wherein means are provided for the generation of the inverse transforms before they are written into the second memory unit in the processing unit.

10. Device according to claim 6, wherein the Fourier transform or the inverse Fourier transform of the pixels contained in the encoding surface is stored in the second memory unit.

11. Device according to claim 7, wherein the Fourier transform or the inverse Fourier transform of the pixels contained in the encoding surface is stored in the second memory unit.
